(19) United States
(12) Patent Application Publication
(10) Pub. No.: US 2014/0132690 A1
(43) Pub. Date: May 15, 2014

(54) LIQUID EJECTING APPARATUS

(71) Applicant: SEIKO EPSON CORPORATION, Tokyo (JP)

(72) Inventors: Yoshitaka SHIMADA, Matsumoto-shi (JP); Kiyotaka OGURA, Azumino-shi (JP)

(73) Assignee: SEIKO EPSON CORPORATION, Tokyo (JP)

(21) Appl. No.: 14/077,047

(22) Filed: Nov. 11, 2013

(30) Foreign Application Priority Data
Nov. 12, 2012 (JP) 2012-248321

(51) Int. Cl. B41J 11/00

(52) U.S. Cl. CPC B41J 11/0005
USPC 347/104

(57) ABSTRACT

A liquid ejecting apparatus includes a liquid ejecting section that ejects ink onto a paper-sheet which is transported in a transportation-direction; a first medium support member that supports the paper-sheet and has suction holes which allow a suction force to be applied on the paper-sheet, the suction holes being arranged on the first medium support member in a width-direction which is perpendicular to the transportation-direction; and a second medium support member that supports the paper-sheet and has suction holes which allow a suction force to be applied on the paper-sheet, the suction holes being arranged in pairs on the second medium support member at positions which correspond to end portions of the paper-sheet in the width-direction, wherein the distance between a pair of suction holes on the second medium support member in the width-direction is larger than that between the adjacent suction holes on the first medium support member.

### BACKGROUND

1. Technical Field

The present invention relates to liquid ejecting apparatuses that eject liquid onto a medium which is suctioned onto a medium support member.

2. Related Art

Liquid ejecting apparatuses that are capable of ejecting liquid include ink jet printers that perform printing on a roll paper by ejecting ink onto a sheet of paper of the roll when the sheet of paper is transported on a medium support member. Since the sheet of paper is held in a cylindrically rolled state, the sheet of paper has curling in the longitudinal direction and may be lifted from the surface of the medium support member. This causes deviation in landing position of ink on the sheet of paper (roll paper), leading to reduced printing quality.

JP-A-2007-276960 discloses a printer that performs printing on a roll paper and the like. The printer prevents a sheet of paper from being lifted due to curling by applying a suction force on the sheet of paper through suction holes which are formed on a medium support member so that the sheet of paper is suctioned onto the medium support member during printing.

The sheet of paper absorbs ink and swells immediately after printing. Due to this swelling, the sheet of paper may be undulated into small wave-like shape. The undulation caused by swelling is also called cockling. The wave-like shape of undulation is often formed in the short direction of the sheet of paper (which is perpendicular to the transportation direction). When printing is performed remaining margins on the end portions of the sheet of paper, the extent of undulation due to cockling tends to increase at the end portions of sheet of paper. If the surface of the sheet of paper which is undulated due to swelling comes into contact with a liquid ejecting section or parts near the liquid ejecting section, the printed image has a defect, thereby reducing the quality.

Such cockling can be reduced by providing increased number of suction holes through which the suction force is applied on the sheet of paper. However, as the number of suction holes increases, the problem arises that the suction force applied on the sheet of paper largely varies depending on the number of suction holes which are covered with the sheet of paper during transportation of the sheet of paper. Further, if a plurality of suction mechanisms that apply suction force on the sheet of paper is provided corresponding to a plurality of groups of suction holes and is selectively actuated to prevent the suction force from varying, the problem arises that a configuration of the apparatus becomes complicated.

The above problems are present not only in printers that print on a roll paper but also in liquid ejecting apparatuses in general that eject liquid onto a medium which is suctioned onto a medium support member.

### SUMMARY

An advantage of some aspects of the invention is that a liquid ejecting apparatus which is capable of efficiently preventing undulation of the medium while reducing variation in suction force by using a simple configuration is provided.

Means for solving the above problems and advantages of the invention will be described below. According to an aspect of the invention, a liquid ejecting apparatus includes a liquid ejecting section that ejects liquid onto a medium which is transported in a transportation direction; a suction mechanism that is configured to suction the medium; a first medium support member that supports the medium at a position which opposes the liquid ejecting section and has two or more first suction holes which allow a suction force of the suction mechanism to be applied on the medium, the first suction holes being arranged on the first medium support member in a width direction which is perpendicular to the transportation direction; and a second medium support member that supports the medium at a position downstream to the first medium support member in the transportation direction and has second suction holes which allow a suction force of the suction mechanism to be applied on the medium, the second suction holes being arranged in pairs on the second medium support member at positions which correspond to end portions of the medium in the width direction, wherein a distance between a pair of the second suction holes in the width direction is larger than a distance between adjacent first suction holes in the width direction.

With this configuration, the medium is suctioned through the first suction holes on the first medium support member. Accordingly, variation in the distance between the medium on which the liquid is applied and the liquid ejecting section can be reduced. Further, the suction holes are provided on the second medium support member at positions which correspond to the end portions of the medium in the width direction. Accordingly, the undulation of the medium can be efficiently reduced while preventing variation in suction force by using a simple configuration.

According to the above aspect of the invention, the liquid ejecting apparatus further includes a feeding unit that rotates a roll which is formed of the medium rolled into a cylindrical shape so as to unwind the medium from the roll, wherein a step is formed between the first medium support member and the second medium support member such that a level of the second medium support member is lower than a level of the first medium support member.

With this configuration, the step is formed between the first medium support member and the second medium support member. Accordingly, the leading edge of the medium which curves due to curling can be supported by the second medium support member, thereby preventing the medium from being lifted on the first medium support member.

According to the above aspect of the invention, in the liquid ejecting apparatus, three or more recesses are arranged on the first medium support member at positions which oppose the liquid ejecting section across the entire length in the width direction, and the first suction holes are disposed on inner bottom surfaces of the recesses.

With this configuration, the recesses are arranged on the first medium support member across the entire length in the width direction with the first suction holes each disposed on the inner bottom surface of the recesses. Accordingly, the medium is suctioned toward inside of the recesses so that the medium is regularly undulated in the width direction, thereby preventing the medium from being irregularly undulated in the transportation direction. Further, the recesses on the first medium support member are disposed at positions which oppose the liquid ejecting section. Accordingly, deviation in landing positions of ink can be reduced by correcting irregular undulation of the medium.

According to the above aspect of the invention, in the liquid ejecting apparatus, an opening area of each of the second suction holes is larger than an opening area of each of the first suction holes. With this configuration, the second suction holes each have an opening area larger than that of the first suction holes. Accordingly, a larger suction force can be applied on the medium so that the medium is suctioned onto the second medium support member while preventing undulation due to swelling.

According to the above aspect of the invention, in the liquid ejecting apparatus, the medium is a transfer medium on which a transfer image is formed by receiving the liquid while remaining margins on the end portions in the width direction, the transfer image being formed to be transferred to a target medium, and a pair of transportation rollers is further provided upstream to the liquid ejecting section in the transportation direction.

With this configuration, the pair of transportation rollers is disposed upstream to the liquid ejecting section in the transportation direction. Accordingly, even if the liquid applied on the medium is undried, the pair of transportation rollers can transport the medium without coming into contact with the undried liquid. Moreover, although the medium tends to have larger undulation near the margins on the end portions in the width direction, it is possible to prevent such undulation since the end portions of the medium are suctioned through the second suction holes which are disposed on the second medium support member.

According to the above aspect of the invention, the liquid ejecting apparatus further includes a wall so that a gap through which the medium passes is formed between the wall and the second medium support member, wherein the second suction holes are disposed upstream to the wall in the transportation direction.

With this configuration, the second suction holes are disposed upstream to the wall in the transportation direction. Accordingly, the medium is prevented from coming into contact with the wall when passing through the gap, since the medium is suctioned onto the second medium support member.

### BRIEF DESCRIPTION OF THE DRAWINGS

The invention will be described with reference to the accompanying drawings, wherein like numbers reference like elements.

FIG. 1 is a perspective view of a liquid ejecting apparatus according to an embodiment.

FIG. 2 is a sectional view which shows a schematic configuration inside of the housing.

FIG. 3 is a top view which shows a schematic configuration at the periphery of a medium support member.

FIG. 4 is a sectional view which explains an operation of a suction hole formed on a first medium support member.

FIG. 5 is a sectional view which explains an operation of a suction hole formed on a second medium support member.

### DESCRIPTION OF EXEMPLARY EMBODIMENTS

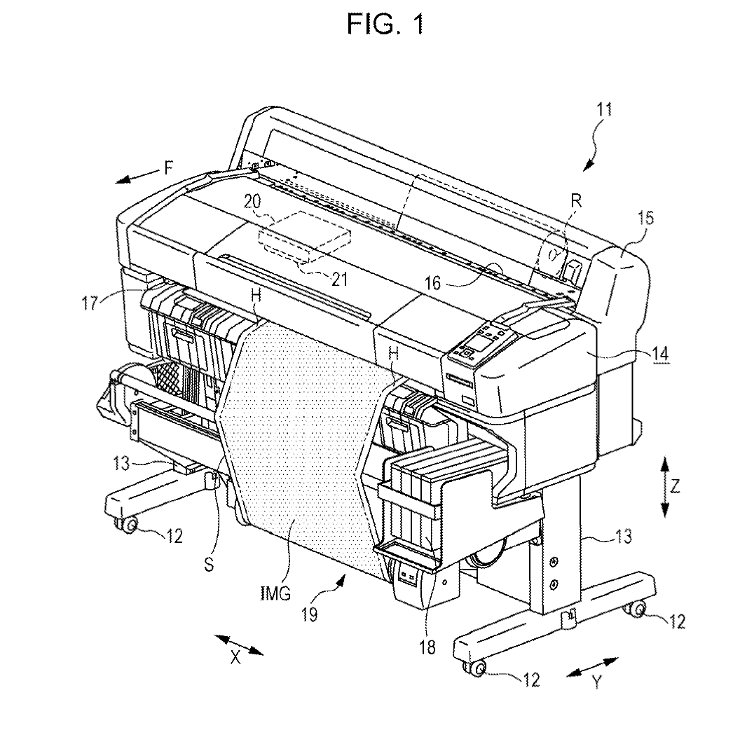

An embodiment of a liquid ejecting apparatus will be described below with reference to the drawings. As shown in FIG. 1, a liquid ejecting apparatus 11 of this embodiment includes legs 13 with wheels 12 mounted on the lower end of the respective legs 13 and a housing 14 which is assembled on the legs 13. In this embodiment, a longitudinal direction of the housing 14 is defined as a width direction X, which traverses (in this embodiment, which is perpendicular to) an up-down direction Z that extends in the gravitational direction. Further, a direction which traverses (in this embodiment, which is perpendicular to) both the up-down direction Z and the width direction X is defined as a front-back direction Y.

A feeding unit 15 is provided on the back side of the housing 14 and extends upward. A roll R formed of a paper sheet S which is an example of a medium rolled into a cylindrical shape is loaded in the feeding unit 15. In this embodiment, the paper sheet S is a roll paper and also a transfer medium (transfer paper) for sublimation transfer textile printing. A transfer image (mirror image) IMG which is formed on the paper sheet S remaining margins H at the end portions in the width direction X, which is a short direction, is transferred onto a target medium (for example, a polyester fabric). The liquid ejecting apparatus 11 of this embodiment is an ink jet printer that forms the transfer image IMG by ejecting sublimation ink for textile printing onto the paper sheet S.

Various sizes of rolls R having different widths (lengths in the width direction X which is the short direction) and different numbers of windings are replaceably loaded in the feeding unit 15. The roll R is loaded in the feeding unit 15 with a first side (the right side in FIG. 1) in the width direction X being aligned, regardless of the size of roll R. The feeding unit 15 is configured to rotate the roll R, thereby unwinding the paper sheet S from the roll R and feeding the paper sheet S into the housing 14.

The housing 14 has an insertion port 16 disposed at a position on the front side of the feeding unit 15 so that the paper sheet S which has been fed from the feeding 15 is introduced into the housing 14 through the insertion port 16. The housing 14 also has an output port 17 disposed on the front side thereof so that the paper sheet S is output to the outside of the housing 14 through the output port 17.

Liquid storing containers 18 for storing ink are mounted on the lower portion of the housing 14 on the first side (the right side in FIG. 1) in the width direction X at a position outside of a transportation path of the paper sheet S. Further, a winding unit 19 is mounted on the legs 13 at the front and under the housing 14.

A carriage 20 is housed in the housing 14 and is configured to reciprocate in a main scan direction (in this embodiment, in the width direction X) that is perpendicular to the transportation direction F of the paper sheet S. Further, a liquid ejecting section 21 that ejects ink is held on the underside of the carriage 20. Printing is performed when the liquid ejecting section 21 ejects ink which has been supplied from the liquid storing containers 18 onto the paper sheet S. After the transfer image IMG is formed on the paper sheet S, the paper sheet S is output from the housing 14 through the output port 17 and is then wound by the winding unit 19.

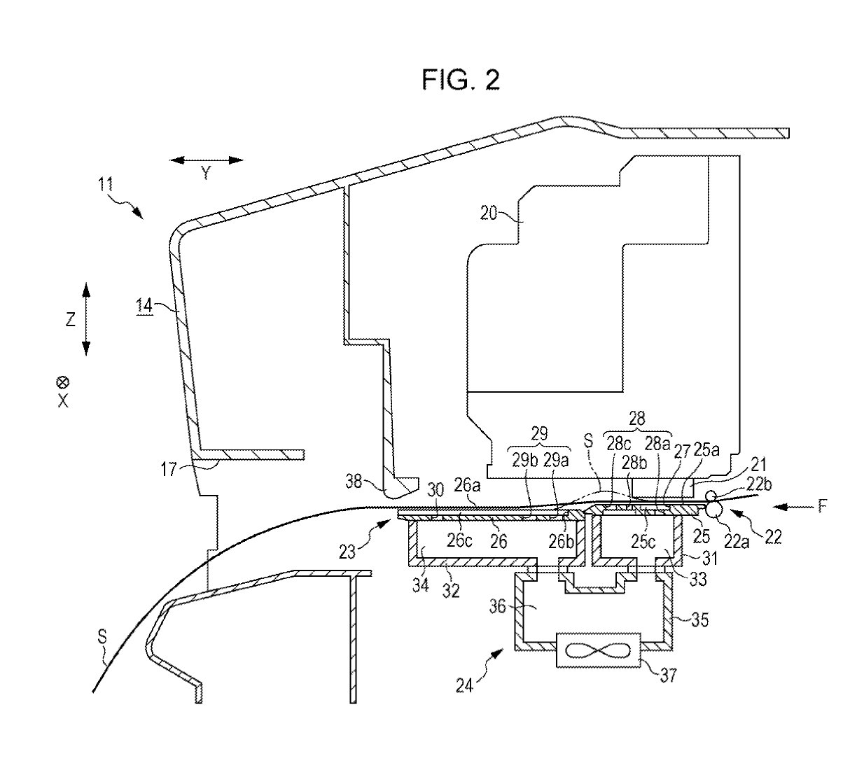

As shown in FIG. 2, a pair of transportation rollers 22, a medium support member 23 that supports the transported medium and a suction mechanism 24 that suctions the paper sheet S are disposed in the housing 14.

The pair of transportation rollers 22 is placed upstream to the liquid ejecting section 21 and the medium support member 23 in the transportation direction F. The pair of transportation rollers 22 is composed of a driving roller 22a which is placed under the transportation path and rotates by means of a driving source, which is not shown in the figure, and a driven roller 22b which cooperates with the driving roller 22a to nip the paper sheet S therebetween.

The center of rotation of the driven roller 22b is located downstream to the center of rotation of the driving roller 22a in the transportation direction F. Accordingly, as the driving roller 22a rotates, the pair of transportation rollers 22 transports the paper sheet S on the medium support member 23 while the driven roller 22b presses the paper sheet S against the upper surface of the medium support member 23.

The medium support member 23 includes a first medium support member 25 that is disposed at a position which opposes the liquid ejecting section 21 and a second medium support member 26 that is disposed downstream to the first medium support member 25 in the transportation direction F. The first medium support member 25 and the second medium support member 26 has a plate shape with the longitudinal direction extending in the width direction X. The upper surface of the first medium support member 25 provides a first support surface 25a that supports the paper sheet S. Further, the upper surface of the second medium support member 26 provides a second support surface 26a that supports the paper sheet S.

A step is formed between the first support surface 25a and the second support surface 26a such that the level of the second support surface 26a of the second medium support member 26 is lower than the level of the first support surface 25a of the first medium support member 25.

Three or more recesses 27 are arranged on the first medium support member 25 across the entire length in the width direction X, spaced from each other by a specific interval at positions which oppose the liquid ejecting section 21. The respective recesses 27 are open upward.

A plurality of suction holes 28 are formed on the first medium support member 25. In this embodiment, the suction holes 28a, 28b, 28c are arranged from upstream to downstream in the transportation direction F. The most upstream suction holes (first suction holes) 28a are each disposed on the inner bottom surfaces of the recesses 27. The suction holes 28b which are located between the most upstream suction holes 28a and the most downstream suction holes 28c in the transportation direction F each have an opening area smaller than that of the suction holes 28a, 28c.

Three or more recesses 26 are arranged on the first medium support member 26 across the entire length in the width direction X, spaced from each other by a specific interval at positions which oppose the liquid ejecting section 27. The respective recesses 26b are open upward and forward (the left side in FIG. 2). In this embodiment, a depth of the recess 26b (the length in the up-down direction Z from the second support surface 26b to the inner bottom surface of the recess 26b) is 0.5 mm, which is smaller than that of the recess 27. It should be noted that the depth of the recesses 27, 26b may be changed as appropriate.

Further, suction holes 29 (29a, 29b) and suction holes (second suction holes) 30 are formed on each of the inner bottom surfaces of the recesses 26b of the second medium support member 26. The suction holes 29a, 29b, 30 are arranged from upstream to downstream in the transportation direction F and have the same opening area. The suction holes 29, 30 on the second medium support member 26 each have an opening area larger than that of the suction holes 28a, 28b, 28c.

The most downstream suction holes 30 in the transportation direction F on the second medium support member 26 are disposed at positions away from the suction holes 29a, 29b which are located upstream to the suction holes 30 in the transportation direction F. That is, the suction holes 29a, 29b are located near the upstream end of the second medium support member 26 in the transportation direction F, while the suction holes 30 are located near the downstream end of the second medium support member 26.

A first frame member 31 having a bottomed box shape which is open upward is assembled to the lower side of the first medium support member 25. Further, a second frame member 32 having a bottomed box shape which is open upward is assembled to the lower side of the second medium support member 26. The first medium support member 25 and the first frame member 31 form a first negative pressure chamber 33. The second medium support member 26 and the second frame member 32 form a second negative pressure chamber 34.

A suction chamber forming member 35 formed in a boxed shape is disposed under the first frame member 31 and the second frame member 32. The suction chamber forming member 35 forms a suction chamber 36 that communicates with the first negative pressure chamber 33 and the second negative pressure chamber 34. An exhaust fan 37 is mounted on the suction chamber forming member 35 so as to exhaust air in the suction chamber 36 to the outside. The first frame member 31, the second frame member 32, the suction chamber forming member 35 and the exhaust fan 37 form a suction mechanism 24.

As the air in the suction chamber 36 is exhausted by rotation of the exhaust fan 37, the pressure inside the suction chamber 36, the first negative pressure chamber 33 and the second negative pressure chamber 34 becomes negative. As a consequence, air is suctioned into the first negative pressure chamber 33 and the second negative pressure chamber 34 through the suction holes 28, 29, 30. Accordingly, a suction force is applied on the paper sheet S, thereby allowing the paper sheet S to be suctioned onto the medium support member 23.

Further, a wall 38 is disposed at a position above the downstream end of the second medium support member 26 in the transportation direction F. The wall 38 and the second medium support member 26 forms a gap therebetween so as to allow the paper sheet S to pass through. The wall 38 is provided to decrease the size of opening of the output port 17 in order to prevent a user's hand or the like from being inserted through the output port 17 into the housing 14. Accordingly, the gap between the second medium support member 26 and the wall 38 has a length in the up-down direction Z smaller than that the output port 17. The suction holes 30 of the second medium support member 26 are disposed upstream to the wall 38 in the transportation direction F.

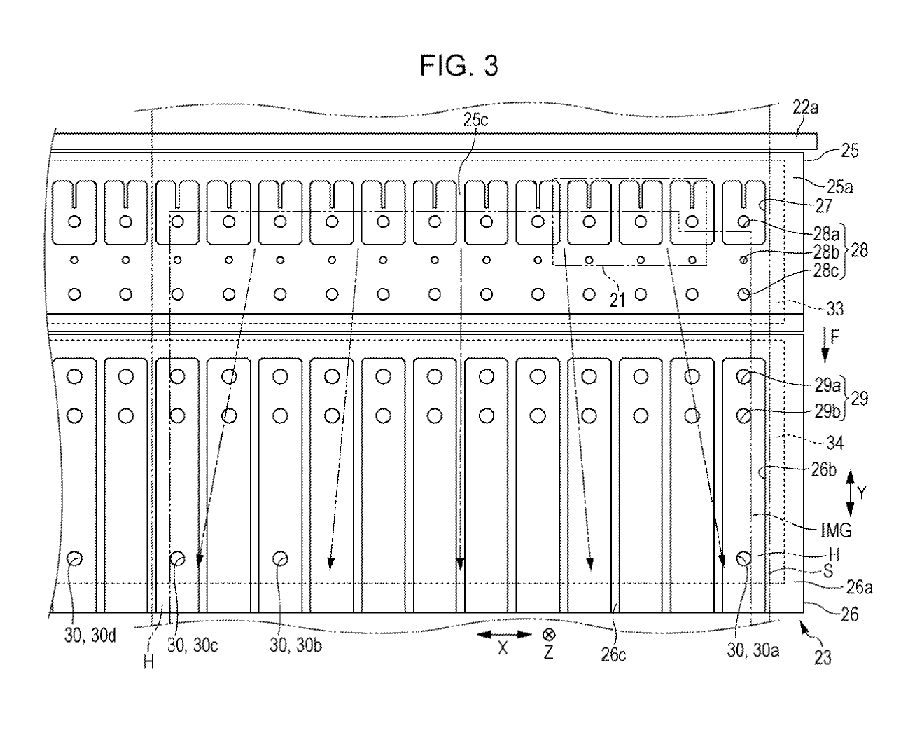

As shown in FIG. 3, the plurality of recesses 27 and the plurality of suction holes 28, which are arranged on the first medium support member 25 in the width direction X, are substantially equally spaced from each other across the entire length in the width direction X. Since the plurality of recesses 27 are arranged in the width direction X, a plurality of ribs 25c that extend in the transportation direction F are formed between the respective two adjacent recesses 27 in the width direction X on the first medium support member 25. That is, the recesses 27 and the ribs 25c are alternatively arranged in the width direction X on the upper surface of the first medium support member 25.

Further, the plurality of recesses 26b and the plurality of suction holes 29, which are arranged on the second medium support member 26 in the width direction X, are substantially equally spaced from each other across the entire length in the width direction X. Since the plurality of recesses 26b are arranged in the width direction X, a plurality of ribs 25c that extend in the transportation direction F are formed between the respective two adjacent recesses 26b in the width direction X on the second medium support member 26. That is, the recesses 26b and the ribs 26c are alternatively arranged in the width direction X on the upper surface of the second medium support member 26.

In this embodiment, the length (width) of the ribs 25c, 26c in the width direction X is 2 mm, while the length (height) of the rib 26c in the up-down direction Z is 0.5 mm, which is smaller than that of the rib 25c. It should be noted that the width, height of the ribs 25c, 26c (the depth of the recesses 27, 26b) and the length in the transportation direction F of the ribs 25c, 26c may be changed as appropriate.

The suction holes 30 on the second medium support member 26 are arranged in pairs at positions which correspond to the end portions of the paper sheet S in the width direction X. Although various paper sheets S having different length (width) in the width direction X may be transported on the medium support member 23, the paper sheet S is always transported with the first side (the right side in FIG. 3) in the width direction X being aligned. Accordingly, the suction hole 30 (30a) is disposed on the first side (the right side in FIG. 3) in the width direction X on the second medium support member 26.

In addition, a plurality of suction holes 30 (30b, 30c, 30d) are disposed on a second side (the left side in FIG. 3) in the width direction X on the second medium support member 26 in order to correspond to different widths of the paper sheet S. That is, each of the suction holes 30b, 30c, 30d are paired with the suction hole 30a. Depending on the width of the paper sheet S, a distance between the suction holes 30b and 30c or between the suction holes 30c and 30d may be smaller than that between the adjacent suction holes 28, 29 in the width direction X. However, the distance between a pair of suction holes 30a and 30b, a pair of suction holes 30a and 30c, a pair of suction holes 30a and 30d are larger than that between the adjacent suction holes 28, 29 in the width direction X.

That is, two or more suction holes 28, 29, 30 are arranged in the width direction X on the first medium support member 25 and the second medium support member 26. The distance between a pair of suction holes 30 (for example, between the suction holes 30a and 30b) in the width direction X is larger than that between the adjacent suction holes 28, 29.

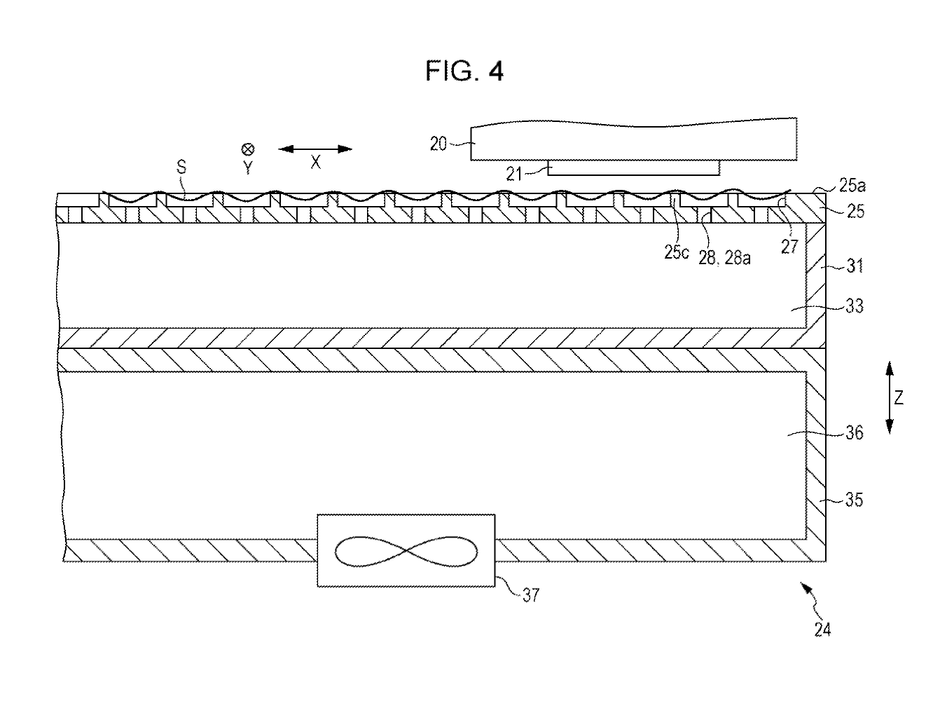

Next, an operation of the foregoing liquid ejecting apparatus 11 will be described below. As shown in FIG. 4, when the liquid ejecting section 21 ejects ink onto the paper sheet S, the exhaust fan 37 rotate, which causes the paper sheet S to be suctioned onto the first support surface 25a of the first medium support member 25. On the first medium support member 25, the suction holes 28 which allows the suction force of the suction mechanism 24 to be applied on the paper sheet S and the recesses 27 are disposed across the entire length in the width direction X which perpendicular to the transportation direction F. The suction holes 28 are formed in the respective recesses 27 of the first medium support member 25.

Accordingly, when the exhaust fan 37 rotates and the pressure inside the suction chamber 36 and the first negative pressure chamber 33 becomes negative, the pressure inside the recesses 27 whose openings are covered with the paper sheet S also becomes negative. As a consequence, the paper sheet S is suctioned toward inside of the recesses 27 while being supported by the ribs 25c. The paper sheet S is suctioned onto the first support surface 25a of the first medium support member 25 while being undulated into a wave-like shape in the width direction X.

Since the paper sheet S is suctioned by the suction force of the suction mechanism 24, the paper sheet S has small undulations in the width direction X along the array of recesses 27. Accordingly, the curling of the paper sheet S in the longitudinal direction, which is due to having been rolled into a cylindrical shape, is corrected. That is, if the suction force is not applied on the paper sheet S, the paper sheet S may be curved as indicated by the double-dotted dashed line in FIG. 2 and come into contact with the liquid ejecting section 21. In this embodiment, however, the curling is corrected, thereby preventing the paper sheet S from coming into contact with the liquid ejecting section 21.

Further, as shown in FIG. 2, although the upstream portion of the paper sheet S is lifted from the medium support member 23 due to the curling with the leading edge curving downward, the level of the second medium support member 26 is located lower than the level the first medium support member 25 since the step is formed between the first medium support member 25 and the second medium support member 26. The leading edge of the paper sheet S is supported by the lower second medium support member 26, thereby preventing the paper sheet S from being lifted from the first medium support member 25.

If the paper sheet S is lifted from the first medium support member 25, the distance between the paper sheet S and the liquid ejecting section 21 varies. This causes deviation in landing position of ink on the paper sheet S, leading to reduced printing quality. In this embodiment, however, the variation in the distance between the paper sheet S and the liquid ejecting section 21 is reduced since the paper sheet S is suctioned onto the first medium support member 25. That is, the suction holes 28 disposed on the first medium support member 25 are necessary to prevent the paper sheet S from coming into contact with the liquid ejecting section 21 and also to keep the distance between the paper sheet S and the liquid ejecting section 21 constant so as to maintain the printing quality. Accordingly, the suction holes 28 are preferably disposed across the entire length in the width direction X.

When the exhaust fan 37 rotates and the pressure inside the suction chamber 36 and the second negative pressure chamber 34 becomes negative, the pressure inside the recesses 26b whose openings are covered with the paper sheet S also becomes negative. Accordingly, the paper sheet S is suctioned toward the second medium support member 26 through the suction holes 29, 30 which are disposed on each of the inner bottom surfaces of the recesses 26b.

Since the suction holes 29, 30 on the second medium support member 26 each have an opening area larger than that of the suction holes 28a on the first medium support member 25, a larger suction force can be applied on the paper sheet S so that the paper sheet S is suctioned onto the second medium support member 26 while preventing the paper sheet S from being lifted due to curling or swelling.

Specifically, a larger suction force is necessary at the upstream portion of the second medium support member 26 in the transportation direction F so that the paper sheet S which is supported on the first support surface 25a located at a position higher than the second support surface 26a is suctioned onto the second medium support member 26. Accordingly, the suction holes 29 are preferably disposed across the entire length in the width direction X and also have an opening area larger than that of the suction holes 28.

Moreover, the suction holes 30 on the second medium support member 26 are disposed upstream to the wall 38 in the transportation direction F. Accordingly, when the paper sheet S is suctioned onto the second medium support member 26, the paper sheet S is prevented from coming into contact with the wall 38.

The paper sheet S, which is a transfer paper, may have a coating to prevent ink from bleeding to the backside so that the ink (transfer image) can be transferred to the target medium. Accordingly, ink applied on the paper sheet S does not tend to dry quickly, compared with the case that ink is applied on copy papers or the like for printing a finished image. If undried ink on the surface of the paper sheet S comes into contact with the liquid ejecting section 21, the wall 38 or the like, the ink applied on that portion may come off. This causes missing in the transferred image on the target medium, which leads to a reduced quality.

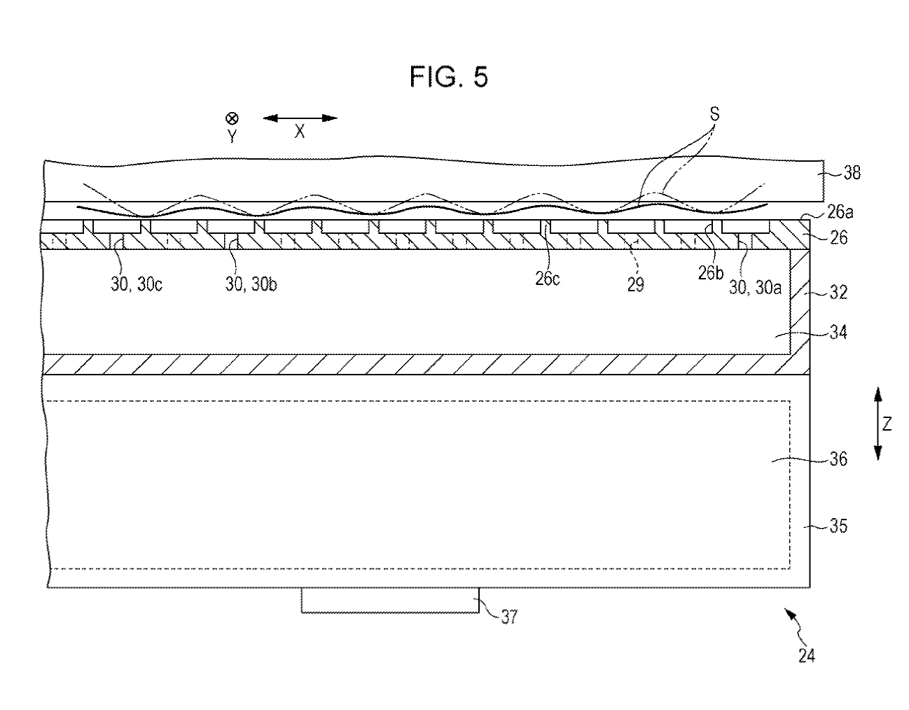

Moreover, the paper sheet S, which is a transfer paper, needs to receive a sufficient amount of ink which allows for textile printing on the target medium such as a fabric. As a consequence, the paper sheet S has undulation due to swelling to a greater extent than plain papers. When a print area of the paper sheet S swells, waves of undulation expand toward the end portions of the paper sheet S in the width direction X as indicated by the arrow in FIG. 3. The waves of undulation are combined at near the end portions of the paper sheet S, and the paper sheet S may be largely lifted as shown in FIG. 5.

When printing is performed remaining margins on the end portions of the paper sheet S, undulation is not released at the end portions. Accordingly, the extent of undulation increases at the end portions of the paper sheet S in the width direction X as shown by double-dotted dashed line in FIG. 5. Further, when printing is performed without remaining margins on the end portions of the paper sheet S, the extent of undulation at the end portions may also become larger relative to the remaining portion if a small amount of ink is ejected on the end portions.

In this embodiment, the suction holes 30 which allow the suction force of the suction mechanism 24 to be applied on the paper sheet S are arranged in pairs on the second medium support member 26 at positions which correspond to the end portions of the paper sheet S in the width direction X. Accordingly, when the suction force of the suction mechanism 24 is applied on the end portions of the paper sheet S in the width direction X, the paper sheet S is prevented from being undulated. As a result, the paper sheet S is prevented from coming into contact with the wall 38.

It is also possible to prevent undulation (cockling) of the paper sheet S due to swelling by providing the suction holes 30 across the entire width of the second medium support member 26. However, in the case where the edges of the paper sheet S do not reach the suction holes 30 or where the paper sheet S has a small width, air may be suctioned through the suction holes 30 which are not covered with the paper sheet S. As a result, it is necessary to increase the suction force of the exhaust fan 37 so that negative pressure is generated in the second negative pressure chamber 34 and the recesses 26b. This causes an increase in size and manufacturing cost of the apparatus. In this embodiment, since the suction holes 30 are disposed specifically at positions which correspond to the end portions of the paper sheet S, undulation of the paper sheet S can be effectively reduced while preventing variation in suction force.

In addition, the paper sheet S is suctioned onto the medium support member 23 while being supported by the ribs 25c, 26c. Accordingly, the edges of the paper sheet S are less likely to be caught by the suction holes 28a, 29, 30. Moreover, when the paper sheet S slides against the support surfaces 25a, 26a, static electricity may be generated and interfere with the transportation of the paper sheet S. In this embodiment, however, the recesses 27, 26b can reduce the contact surface area between the paper sheet S and the support surfaces 25a, 26a, thereby reducing generation of static electricity. Further, the negative pressure generated in the recesses 27, 26b is used to suction the paper sheet S. Accordingly, the suction force can be applied on a larger area of the paper sheet S.

According to the above-mentioned embodiment, the following effect can be achieved:

(1) The paper sheet S is suctioned through the suction holes 28 on the first medium support member 25. Accordingly, variation in the distance between the paper sheet S on which ink is applied and the liquid ejecting section 21 can be reduced. Moreover, the suction holes 30 are provided on the second medium support member 26 at positions which correspond to the end portions of the paper sheet S in the width direction X. Accordingly, the undulation of the paper sheet S can be efficiently reduced while preventing variation in suction force by using a simple configuration.
(2) The step is formed between the first medium support member 25 and the second medium support member 26. Accordingly, the leading edge of the paper sheet S which curves due to curling can be supported by the second medium support member 26, thereby preventing the paper sheet S from being lifted on the first medium support member 25.
(3) The recesses 27 are arranged on the first medium support member 25 across the entire length in the width direction X with the suction holes 28a each disposed on the inner bottom surface of the recesses 27. Accordingly, the paper sheet S is suctioned toward inside of the recesses 27 so that the paper sheet S is regularly undulated in the width direction X, thereby preventing the paper sheet S from being irregularly undulated in the transportation direction F. Further, the recesses 27 on the first medium support member 25 are disposed at positions which oppose the liquid ejecting section 21. Accordingly, deviation in landing positions of ink can be reduced by correcting irregular undulation of the paper sheet S.
(4) The suction holes 30 each have an opening area larger than that of the suction holes 28. Accordingly, a larger suction force can be applied on the paper sheet S so that the paper sheet S is suctioned onto the second medium support member 26 while preventing undulation due to swelling.
(5) The pair of transportation rollers 22 is disposed upstream to the liquid ejecting section 21 in the transportation direction F. Accordingly, even if the ink applied on the paper sheet S is undried, the pair of transportation rollers 22 can transport the paper sheet S without coming into contact with the undried ink. Moreover, although the paper sheet S tends to have larger undulation near the margins H on the end portions in the width direction X, it is possible to prevent such undulation since the end portions of the paper sheet S are suctioned through the suction holes 30 which are disposed on the second medium support member 26.

The suction holes 30 on the second medium support member 26 are disposed upstream to the wall 38 in the transportation direction F. Accordingly, the paper sheet S is prevented from coming into contact with the wall 38 when passing through the gap, since the paper sheet S is suctioned onto the second medium support member 26.

Moreover, the following modifications can be made to the above-mentioned embodiment:

When printing is performed without remaining margins, a receiving recess that receives ink which comes out of the paper sheet S may be provided on the first medium support member 25 at a position which is aligned with the recesses 27 in the width direction X and corresponds to the end portion of the paper sheet S.

The step may be provided such that the level of the second medium support member 26 is higher than the level of the first medium support member 25.

The step may not be provided between the first medium support member 25 and the second medium support member 26.

The first medium support member 25 and the second medium support member 26 may be formed of the same member.

The suction holes 28b, 28c, 30c, 30d may not be provided.

The suction holes 28, 29 may not be provided with equal intervals in the width direction X. In the above embodiment, the suction holes 28, 29 are provided at positions which correspond to the end portions of the medium in the width direction X and in the inner area of those end portions, in a similar manner to the suction holes 30. However, the suction holes 28, 29 are not necessarily provided at positions which correspond to the end portions in a similar manner to the suction holes 30.

The recesses 27 may not be provided. That is, the paper sheet S may be suctioned onto the medium support member 23 without being undulated in the width direction X at the position which opposes the liquid ejecting section 21.—The arrangement and the number of the suction holes 28, 29 in the transportation direction F may be modified as appropriate.

—The arrangement and the number of the suction holes 30b, 30c, 30d may be modified as appropriate depending on the width of the paper sheet S.

The suction holes 28, 29, 30 may be formed in an elongated shape having a longitudinal direction in the transportation direction F or the width direction X. If the suction holes 28a are formed in an elongated shape which extends in the width direction X, the paper sheet S can be suctioned across the entire width by two suction holes 28a arranged in the width direction X. However, if the suction holes 28a are not formed in an elongated shape which extends in the width direction X, it is preferable to provide three or more suction holes 28a arranged in the width direction X on the first medium support member 25.

The opening area of the suction holes 28 may be equal to that of the suction holes 29, 30. Alternatively, the opening area of the suction holes 28 may be larger than that of the suction holes 29, 30.

Two or more suction holes 30a which are arranged in the width direction X may be provided on the first side of the second medium support member 26 in the width direction X. Alternatively, two or more suction holes 30a which are arranged in the transportation direction F may be provided on the first side of the second medium support member 26 in the width direction X. Further, a plurality of suction holes 30b, 30c, 30d which are in pair with the suction holes 30a may be arranged in the width direction X or in the transportation direction F. That is, a plurality of suction holes 30 may be provided so as to correspond to one side of the paper sheet S in the width direction X.

The wall 38 may not be provided. In this configuration, if there is a risk that the paper sheet S comes into contact with an object such as the output port 17 of the housing 14 and other members which are located along the transportation path of the paper sheet S, it is possible to prevent the paper sheet P from coming into contact with such object by providing a suction hole at a position upstream to the object.

The paper sheet S may not be a transfer medium, and may be a pre-cut sheet which is cut by a predetermined length.

In the foregoing embodiments, the liquid ejecting apparatus may be an apparatus that ejects a liquid other than ink. The liquid ejected in the form of fine liquid droplets from the liquid ejecting apparatus may include particle, tear drop or string shaped liquid droplets. The liquid as described herein may be any material that can be ejected from liquid ejecting apparatus. For example, it may include a material in liquid phase such as liquid having high or low viscosity, sol, gel water, other inorganic solvent, organic solvent and liquid solution, and a material in melted state such as liquid resin and liquid metal (molten metal).

Further, in addition to a material in a liquid state, it may include particles of functional material made of solid substance such as pigment and metal particles, which is dissolved, dispersed or mixed in a solvent. Typical examples of liquid include ink as mentioned above, liquid crystal and the like.

The ink as described herein includes various liquid components such as general water-based ink, oil-based ink, gel ink and hot melt ink. Specific examples of liquid ejecting apparatus may include, for example, liquid ejecting apparatuses that eject liquid containing materials such as electrode material and color material in a dispersed or dissolved state, which are used for manufacturing of liquid crystal displays, electro-luminescence (EL) displays, surface emitting displays or color filters.

Further, the examples of liquid ejecting apparatus may include liquid ejecting apparatuses that eject bioorganic materials used for manufacturing biochips, liquid ejecting apparatuses that are used as a precision pipette and eject liquid of a sample, textile printing apparatuses and micro dispensers. The examples of liquid ejecting apparatus may also include liquid ejecting apparatuses that eject lubricant to precision instrument such as a clock or camera in a pin-point manner, liquid ejecting apparatuses that eject transparent resin liquid such as ultraviolet cured resin onto a substrate for manufacturing minute hemispheric lenses (optical lenses) used for optical communication elements or the like, and liquid ejecting apparatuses that eject acid or alkali etching liquid for etching a substrate or the like.

The entire disclosure of Japanese Patent Application No. 2012-248321, filed Nov. 12, 2012 is expressly incorporated by reference herein.

What is claimed is:

1. A liquid ejecting apparatus comprising:
a liquid ejecting section that ejects liquid onto a medium which is transported in a transportation direction;
a suction mechanism that is configured to suction the medium;
a first medium support member that supports the medium at a position which opposes the liquid ejecting section and has two or more first suction holes which allow a suction force of the suction mechanism to be applied on the medium, the first suction holes being arranged on the first medium support member in a width direction which is perpendicular to the transportation direction; and
a second medium support member that supports the medium at a position downstream to the first medium support member in the transportation direction and has second suction holes which allow a suction force of the suction mechanism to be applied on the medium, the second suction holes being arranged in pairs on the second medium support member at positions which correspond to end portions of the medium in the width direction, wherein a distance between a pair of the second suction holes in the width direction is larger than a distance between adjacent first suction holes in the width direction.

2. The liquid ejecting apparatus according to claim 1, further comprising a feeding unit that rotates a roll which is formed of the medium rolled into a cylindrical shape so as to unwind the medium from the roll, wherein a step is formed between the first medium support member and the second medium support member such that a level of the second medium support member is lower than a level of the first medium support member.

3. The liquid ejecting apparatus according to claim 1, wherein three or more recesses are arranged on the first medium support member at positions which oppose the liquid ejecting section across the entire length in the width direction, and the first suction holes are disposed on inner bottom surfaces of the recesses.

4. The liquid ejecting apparatus according to claim 1, wherein an opening area of each of the second suction holes is larger than an opening area of each of the first suction holes.

5. The liquid ejecting apparatus according to claim 1, wherein the medium is a transfer medium on which a transfer image is formed by receiving the liquid while remaining margins on the end portions in the width direction, the transfer image being formed to be transferred to a target medium, and a pair of transportation rollers is further provided upstream to the liquid ejecting section in the transportation direction.

6. The liquid ejecting apparatus according to claim 1, further comprising a wall so that a gap through which the medium passes is formed between the wall and the second medium support member, wherein the second suction holes are disposed upstream to the wall in the transportation direction.
